(19) United States
(12) Patent Application Publication
(10) Pub. No.: US 2014/0067284 A1
(43) Pub. Date: Mar. 6, 2014

(54) STRUCTURAL MONITORING

(71) Applicant: Intelligent Technologies International, Inc., (US)

(72) Inventor: David S. Breed, Miami Beach, FL (US)

(73) Assignee: Intelligent Technologies International, Inc., Boonton, NJ (US)

(21) Appl. No.: 13/680,147

(22) Filed: Nov. 19, 2012

Related U.S. Application Data
(63) Continuation-in-part of application No. 11/935,819, filed on Nov. 6, 2007, now abandoned.
Application No. 11/935,819 is a continuation-in-part of application No. 10/940,881, filed on Sep. 13, 2004, now Pat. No. 7,663,502.
Application No. 10/940,881 is a continuation-in-part of application No. 10/457,238, filed on Jun. 9, 2003, now Pat. No. 6,919,803.
Application No. 10/940,881 is a continuation-in-part of application No. 10/931,288, filed on Aug. 31, 2004, now Pat. No. 7,164,117.
Application No. 11/935,819 is a continuation-in-part of application No. 11/278,979, filed on Apr. 7, 2006, now Pat. No. 7,386,372.
Application No. 11/278,979 is a continuation-in-part of application No. 10/931,288, filed on Aug. 31, 2004, now Pat. No. 7,164,117.
Application No. 11/935,819 is a continuation-in-part of application No. 11/380,574, filed on Apr. 27, 2006, now Pat. No. 8,159,338.
Application No. 11/380,574 is a continuation-in-part of application No. 10/931,288, filed on Aug. 31, 2004, now Pat. No. 7,164,117.
Application No. 11/935,819 is a continuation-in-part of application No. 11/619,863, filed on Jan. 4, 2007.
Application No. 11/619,863 is a continuation-in-part of application No. 10/931,288, filed on Aug. 31, 2004, now Pat. No. 7,164,117.
Application No. 11/935,819 is a continuation-in-part of application No. 11/755,199, filed on May 30, 2007, now Pat. No. 7,911,324.
Application No. 11/755,199 is a continuation-in-part of application No. 11/843,932, filed on Aug. 23, 2007, now Pat. No. 8,310,363.
Application No. 11/843,932 is a continuation-in-part of application No. 11/865,363, filed on Oct. 1, 2007, now Pat. No. 7,819,003.
(60) Provisional application No. 60/387,792, filed on Jun. 11, 2002.

(51) Int. Cl. G01M 99/00

(52) U.S. Cl. CPC G01M 99/004
USPC 702/34; 73/514.02

(57) ABSTRACT

System for monitoring a structure includes at least one monitoring arrangement attached at a respective location to the structure, each monitoring arrangement having at least one inertial measurement unit (IMU) that measures acceleration and/or angular motion in any direction and rotation about any axis, a Global Navigation Satellite System (GNSS) receiver that determines its location, and a wireless communication system that transmits information derived from acceleration and/or angular motion measured by the IMU and a location determination by the GNSS receiver. Further, each monitoring arrangement may include a microphone, chemical sensor, a visual or IR light sensor, a radiation sensor, a magnetic sensor, and/or a strain sensor. As an alternative, the monitoring arrangements may include only IMUs or only GNSS receivers.

### CROSS REFERENCE TO RELATED APPLICATIONS

This application is a continuation-in-part of U.S. patent application Ser. No. 11/935,819 filed Nov. 6, 2007, which is:

1. a continuation-in-part (CIP) of U.S. patent application Ser. No. 10/940,881 filed Sep. 13, 2004, now U.S. Pat. No. 7,663,502, which is:
A. a CIP of U.S. patent application Ser. No. 10/457,238 filed Jun. 9, 2003, now U.S. Pat. No. 6,919,803 which claims priority under 35 U.S.C. §119(e) of U.S. provisional patent application Ser. No. 60/387,792 filed Jun. 11, 2002, now expired;
B. a CIP of U.S. patent application Ser. No. 10/931,288 filed Aug. 31, 2004, now U.S. Pat. No. 7,164,117;

2. a CIP of U.S. patent application Ser. No. 11/278,979 filed Apr. 7, 2006, now U.S. Pat. No. 7,386,372, which is a CIP of U.S. patent application Ser. No. 10/931,288 filed Aug. 31, 2004, now U.S. Pat. No. 7,164,117;

3. a CIP of U.S. patent application Ser. No. 11/380,574 filed Apr. 27, 2006, now U.S. Pat. No. 8,159,338, which is a CIP of U.S. patent application Ser. No. 10/931,288 filed Aug. 31, 2004, now U.S. Pat. No. 7,164,117;

4. a CIP of U.S. patent application Ser. No. 11/619,863 filed Jan. 4, 2007 which is a CIP of U.S. patent application Ser. No. 10/931,288 filed Aug. 31, 2004, now U.S. Pat. No. 7,164,117;

5. a CIP of U.S. patent application Ser. No. 11/755,199 filed May 30, 2007, now U.S. Pat. No. 7,911,324;

6. a CIP of U.S. patent application Ser. No. 11/843,932 filed Aug. 23, 2007, now U.S. Pat. No. 8,310,363; and

7. a CIP of U.S. patent application Ser. No. 11/865,363 filed Oct. 1, 2007, now U.S. Pat. No. 7,819,003.

All of the foregoing patent applications and all references, patents and patent applications that are mentioned below are incorporated by reference herein in their entirety as if they had each been set forth herein in full.

### FIELD OF THE INVENTION

The present invention relates generally to methods and systems for monitoring structures.

### BACKGROUND OF THE INVENTION

Bridges and other infrastructure are used daily and subject to wear and tear. It is therefore important to be able to continuously and/or continually monitor the structural integrity of bridges and other types of infrastructure, such as tunnels, overpasses and other structures which may be subject to daily wear and tear whether by passage of vehicles or other means. Other structures can be subject to abuse or malicious damage such as dams, buildings, fences or other border structures, roadways, etc. Even amorphous structures, such as the ground, when monitored can provide valuable information such as the occurrence of an earthquake or the passage of people, animals and vehicles.

Definitions in the Background of the Invention section of any of the above-mentioned applications are also generally, but not restrictively, applicable herein.

### OBJECTS AND SUMMARY OF THE INVENTION

A system of monitoring a structure in accordance with the invention includes at least one monitoring arrangement attached at a respective location to the structure, each monitoring arrangement having at least one inertial measurement unit (IMU) that measures acceleration and/or angular motion in any direction and rotation about any axis, a Global Navigation Satellite System (GNSS) receiver that determines its location, and a wireless communication system that transmits information derived from acceleration and/or angular motion measured by the at least one IMU and a location determination by the GNSS receiver. Further, each monitoring arrangement may include at least one sensor selected from a group consisting of a microphone, chemical sensor, biological sensor, a visual or IR light sensor, a radiation sensor, a magnetic sensor, and a strain sensor.

In some embodiments, a wake-up sensor is coupled to the monitoring arrangement(s) and detects one of a predetermined number of conditions that relate to interaction of objects with the structure and for which monitoring of the structure is required. When one of the predetermined number of conditions is detected, the wake-up sensor causes the monitoring arrangement(s) to go from an inactive phase in which data is not obtained to an active phase in which data is not obtained. The wake-up sensor may alternatively or additionally monitor at least one property of a monitoring location or the structure. In this case, when the monitored property exceeds a predetermined level, is below a predetermined threshold, or is within a range of interest detected, the wake-up sensor causes the monitoring arrangement to go from the inactive phase to the active phase.

The communication system may include circuitry capable of providing super Wi-Fi or equivalent, a directional antenna configured to cover only a small angular slice in a vertical plane and a rotation mechanism that rotates the antenna. For super Wi-Fi, instead of using the 2.4 GHz radio frequency of Wi-Fi, super Wi-Fi uses the lower-frequency white spaces between television channel frequencies. These lower frequencies allow the signal to travel further and penetrate walls better than the higher frequencies previously used. Thus, super Wi-Fi is considered typically to refer to unused radio spectrum in TV broadcast bands, typically at 700 MHz, which can be used as an alternative wireless platform to deliver commercial services.

The rotation mechanism may be implemented by having a physically rotating antenna, by using several antennas pointing every 30 degrees, for example, or otherwise electronically changing the effective antenna send and receive direction. The communication system is thus configured to transmit the information, which may have been previously stored, after receiving a signal from the antenna.

An arrangement for determining relative motions between parts of a structure in accordance with the invention includes a plurality of monitoring arrangements each attached at a respective location to the structure and having any of the constructions described above, and a processor, which may be partly or entirely located at the structure or at one or more remote sites, that analyzes the acceleration and/or angular motion, measured by the IMU of the monitoring arrangements and a distance between the monitoring arrangements to determine relative displacement between the locations at which the monitoring arrangements are attached to the structure. The monitoring arrangements are attached to different parts of the structure. The processor is additionally or alternatively configured to analyze the location of the monitoring arrangements provided by the GNSS receivers to determine relative displacements between the locations at which the monitoring arrangements are attached to the structure.

### BRIEF DESCRIPTION OF THE DRAWINGS

The following drawings are illustrative of embodiments of the system developed or adapted using the teachings of at least one of the inventions disclosed herein and are not meant to limit the scope of the invention as encompassed by the claims.

FIG. 1 is a schematic showing a bridge capable of being monitored in accordance with the invention.

FIG. 2 is a flow chart showing the manner in which a bridge or other structure, facility or area can be monitored in accordance with the invention.

FIG. 3 is a schematic showing a structure with monitoring units in a monitoring arrangement in accordance with the invention.

FIG. 4 is a schematic of a monitoring arrangement used in the invention.

FIG. 5 is a schematic of a communication system used in the invention.

### DETAILED DESCRIPTION OF THE INVENTION

Periodically, a boat or barge impacts with the structure of a bridge resulting in the collapse of a road, railroad or highway and often multiple fatalities. Additionally such structures are subject to normal deterioration over time eventually resulting in their failure. Usually such an event can be sensed prior to the collapse of the structure by monitoring the accelerations, vibrations, displacement, and/or stresses in or of the structural members. When such an event is sensed, a message can be sent to a satellite, to the cell phone infrastructure or other communication system, and/or forwarded to the Internet, and thus to the authorities and to a warning sign or signal that has been placed at a location preceding entry onto the bridge. Alternately, the sensing device can send a signal directly to the relevant sign either in addition or instead of to a satellite, or other communication system.

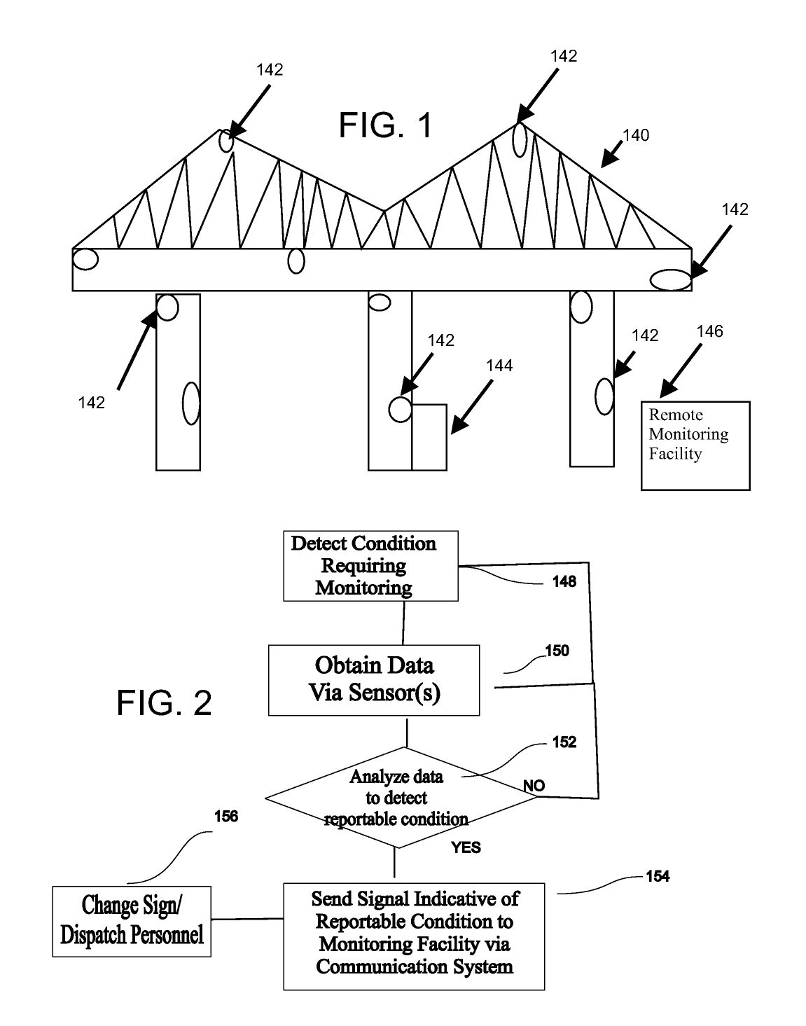

Referring in this regard to FIGS. 1 and 2, a bridge which can be monitored in accordance with the invention is designated generally as 140. Bridge 140 is only representative of different types and forms of structures or infrastructure that can be monitored in accordance with the invention, and which infrastructure includes tunnels, overpasses, other highway structures, buildings, dams, fences, etc. Bridge 140 has a sensor system including a plurality of sensors 142 arranged in connection therewith, e.g., mounted temporarily or permanently thereon.

A map of the mounting location of each sensor 142 relative to the bridge 140 can be provided and stored, for example, in a processor unit 144 which is coupled to the sensors 142 either in a wired manner or wirelessly. The processor unit 144 can also be located at a remote site. Processor unit 144 may be partly arranged at the structure and partly arranged at one or more remote sites, or entirely at the structure or entirely at one or more remote sites. Regardless of its location, the processor unit 144 can associate a reading provided by a sensor 142 with the location of the condition being sensed, measured or detected by that sensor.

Sensors 142 may be any type and form of sensor including, but not limited to, strain sensors which measure strain in the part of the bridge 140 to which they are connected. Such strain sensors are important, since as bridges age, the strain on critical elements changes and if in excess of tolerable limits, can lead to collapse of the bridge or part thereof. Thus, when monitoring a bridge, it is preferred that at least some of the sensors are strain sensors. Also, one or more of the sensors 142 may be a vibration sensor, an infrared radiation sensor, an acoustic or sound sensor or a sensor which senses, measures or detects other disturbances. The vibration sensor function can be performed by an IMU, if provided s one of the sensors 142.

Monitoring of the data provided by the sensors 142 may be performed in the processor unit 144 which receives the data. To this end, the processor unit 144 may be arranged to detect patterns in the data which are indicative of a condition requiring transmission of a report to a remote monitoring facility 146. The processor unit 144 may embody one or more pattern recognition systems, e.g., trained pattern recognition algorithms, neural networks and the like, which analyze the data provided by the sensors 142. For example, a pattern recognition algorithm could be trained to analyze data provided by one or more vibration sensors for the purpose of detecting potentially damaging vibrations in a part of the bridge 140.

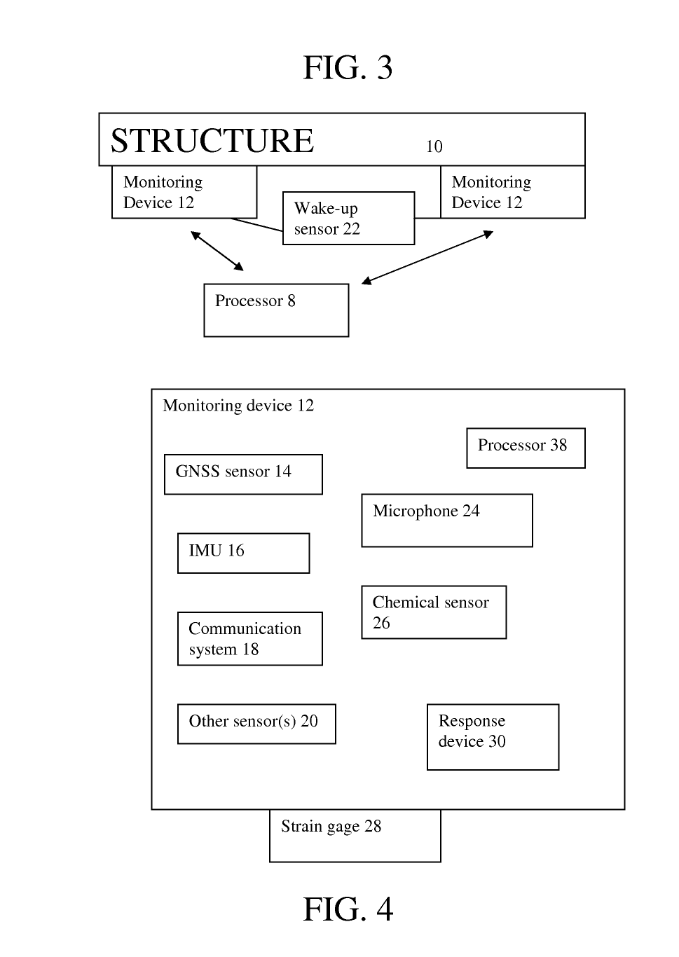

The processor unit 144, if it is locally connected to the bridge sensors, can include a communication portion which is capable of establishing communications with the remote facility 146, e.g., via a satellite (SkyBitz), cell phone infrastructure, and/or via the Internet (WiMax). Alternately, each of the sensors 142 may be integrated or associated with a communication portion capable of establishing communications with a remote facility. A common housing may be provided for a sensor and a communication portion. Thus, a monitoring unit may be formed that can be a self-contained device comprising an IMU, GNSS receiver, other sensors and a communication capability or a plurality of sensors can communicate locally to a processor which performs some analysis and the communication function. This aspect is discussed in detail below with reference to FIGS. 3-5.

In use, a wake-up sensor or other form of sensor is provided to detect a condition requiring monitoring of the bridge 140 (step 148 in FIG. 2) and then the sensors 142 obtain data (step 150). The wake-up sensor may be resident in the processor unit 144 or in each monitoring unit including a sensor and communication portion, and may be a simple timer, e.g., every week a command is generated for the sensors 142 to obtain data, or may be a sensor which detects passage of a certain number of vehicles over the bridge 140, e.g., passage of every 50,000 vehicles requires monitoring of the bridge 140. Alternatively or additionally, the sensors 142 can be caused to obtain data upon command from the monitoring facility 148. Therefore, the processor unit 144 analyzes the data to determine whether a reportable condition is present (step 152), e.g., actual damage to the bridge, excessive vibrations, etc., and if there is no reportable condition, the process either continues to obtain data via the sensors 142 or the sensors 142 return to an inactive phase, awaiting another wake-up command. Thus, the sensors 142 have an active phase, after having been woken-up by the wake-up sensor to obtain data, and an inactive phase in which data is not obtained. If a reportable condition is present, the processor unit 144 generates a signal indicative of the reportable condition and transmits it to the monitoring facility 148 (step 154). The monitoring facility 146 can then change a sign to alert motorists to the condition (e.g., slow down in view of excessive weather-related vibrations) and/or dispatch personnel to the bridge 140 to repair a part thereof.

It is envisioned that the analysis of the data from the sensors 142 does not necessarily have to be performed by means of a processor unit 144 located in proximity to the sensors 142 and the bridge 140 as shown in FIG. 1. Rather, the sensors 142 may be arranged to communicate with the remote monitoring facility 146, e.g., each is provided with a communications unit, and provide data thereto with the remote monitoring facility analyzing the data to determine whether part of the bridge 140 needs to be repaired. Alternatively, the sensors 142 can provide data to the processor unit 144 which transmits the data, without analysis thereof, to the remote monitoring facility 146.

Another arrangement for monitoring a structure 10 is shown in FIG. 3 and includes one or more monitoring devices 12 on the structure 10. As shown in FIG. 4, each monitoring device 12 includes a Global Navigation Satellite System (GNSS) receiver 14, an inertial measurement unit (IMU) 16, a communication system 18, and optionally one or more other sensors such as a microphone, chemical sensor, visual or IR light sensor, radiation sensor, magnetic sensor, and/or strain sensor (represented by other sensors 20). As an alternative, the monitoring devices 12 may include only IMUs or only GNSS receivers.

Monitoring devices 12 can be used to monitor various structures for vibration, corrosion, deflection, movement, and/or relative movement of one part of the structure 10 relative to another. The monitoring devices 12 can also be used to measure other properties of the structure 10 or of the surrounding environment including visibility, radiation, temperature, presence of chemicals or biologicals, pollution, the weather, and/or other environmental properties or factors. Generally, one or more properties or characteristics of the structure 10 and/or the environment around the structure 10 may be measured by instruments or devices in the monitoring device 12, and if necessary, a processor 38 in the monitoring device 12 processes data about the property from the instruments or devices in order to derive a measurement.

For example, the monitoring device 12 can be used to determine the deterioration of the structure 10, to measure pollution in the atmosphere around the structure 10, to measure temperature in the atmosphere around the structure 10, for example, for determining climate change, to count the passage or presence of vehicles or people over, under or through the structure 10, to determine the presence of animals or a pedestrian around the structure 10, to report an incident that is out of the ordinary such as an automobile accident, to report icing or other weather related problem which could require informing users of the structure 10 or to control the conditions under which the structure 10 can be used such as the speed limit for vehicle using the structure 10, to sense terrorist activity, to monitor for earthquakes around the structure 10, to determine infraction of borders, and or to determine the presence of a flood or other water incursion. Any of these capabilities may be provided by the processor 38 processing data from sensors coupled to it, e.g., with wires or wirelessly.

The monitoring devices 12 can thus be used in conjunction with bridges, roadways, buildings, dams or other similar structures, structures on borders including fences, waterways, coastlines, and the ground. When monitoring the ground, the presence or passage of moving vehicles or people can be determined.

Each monitoring device 12 can make measurements continuously, on exception, based on the time of day, or based on a command from either a smart phone or a remote site. When measurements are made based on exception, a wake-up sensor 22 can be employed, see FIG. 3. Wake-up sensor 22 monitors one or more properties of the monitoring location or structure 10 and wakes up a sensing device within the monitoring device 12 when that property exceeds a predetermined level, is below a predetermined threshold, is within a range of interest, etc. Generally, wake-up sensor 22 may be designed to detect one of a pre-determined number of conditions that are associated with the need to conduct a monitoring stage, so that when one such condition is detected, monitoring device 12 is brought from an inactive, energy-saving phase into an active phase and begins monitoring of the structure 10 or environment around the structure.

The property or properties to be measured can use any of a variety of low-power conventional sensors. One particular embodiment contains an IMU 16 which is a device typically containing three accelerometers and three gyroscopes and is capable of measuring acceleration and angular motion in any direction and rotation about any axis. A preferred IMU 16 for monitoring device 12 would generally be sensitive to accelerations below about 1 G and angular velocities above about 1° per second. The IMU 16 can be designed to measure only acceleration or only angular motion or both.

If two monitoring devices 12 are placed at different locations on a structure 10 as shown in FIG. 1, then the relative motions of the two locations can be determined by a processor 8 thereby indicating that unwanted relative motions between two parts of the structure 10 are occurring which could be indicative of a pending failure. Sensors located at only one place on the structure 10 may not be capable of detecting this potential failure mode. Processor 8 may be resident locally at the structure, or communicating with the monitoring devices 12 from a remote location separate and apart from the structure 10 via a communications device. This communication may be made using wires, wirelessly, over the internet or combinations thereof.

High speed relative displacements can thus be determined, by processor 8, by comparing readings from the IMU 16 in two different monitoring devices 12 that are displaced from each other and low-speed relative displacements can be determined from the GNSS sensors 14 in these two monitoring devices 12 which would also be displaced relative to each other. The displacement may be known or pre-determined and stored in a memory unit (not shown) accessible to the processor 8, or derived based on a location of each monitoring device 12 provided with the readings, which location may be derived using a location determining system known to those skilled in the art. Thus, two monitoring devices 12 displaced from each other can determine absolute as well as relative displacements of the structure 10 which are occurring rapidly and which are occurring slowly independently.

A microphone 24 can also be present in one or more of the monitoring devices 12 which can be used to determine a variety of sound-based parameters (see FIG. 4). For example, when the structure 10 is a bridge, it has been determined that the sound of rain on a bridge changes as the bridge deteriorates and that this can be used to assess the structural integrity of the bridge.

A chemical sensor 26 such as one based on surface acoustic wave technology or MEMS technology can be used to determine the presence and concentration of a variety of different chemicals and biological agents for which the chemical sensor 26 has been designed (see FIG. 4).

Similarly, a strain gauge 28 can be mounted in conjunction with the monitoring device 12 to measure the state of strain in the structure 10 upon which the monitoring device 12 is mounted (see FIG. 4). Strain measurements can similarly provide indications of changes in the integrity of a structure 10.

The monitoring device 12 also contains a communication system or device 18. Communication system 18 can be based on cell phone infrastructure using SMS or other texting technology or it can communicate directly with the Internet either using DSRC, Wi-Fi, super Wi-Fi, FreedomPop, or other wireless Internet connection system. Dedicated cellular networks are currently being contemplated specifically for the purpose of connecting a large quantity of low-power sensors wirelessly. See for example, www.technologyreview.com/news/507321/cellular-data-network-for-inanimate-objects-goes-live-in-france/.

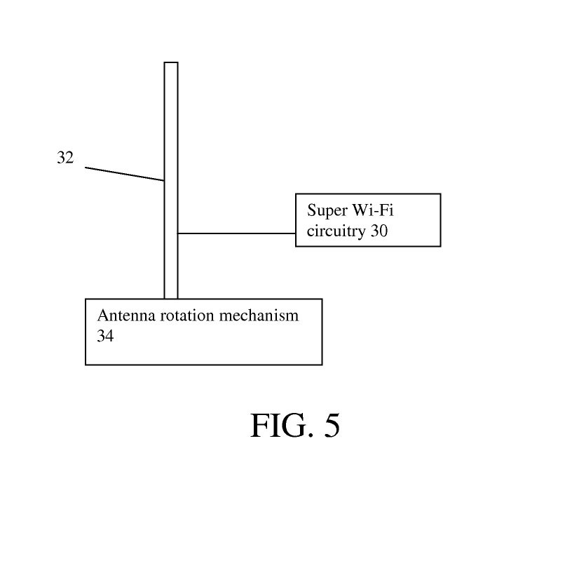

Referring to FIG. 5, one preferred construction for communication system 18 is to use circuitry 30 capable of providing super Wi-Fi or equivalent in conjunction with a directional antenna 32 which is configured to cover a small angular slice in a vertical plane of, for example, from about 5° to about 30°, which then rotates about a vertical axis scanning the environment. When a monitoring device 12 receives a signal from the antenna 32, it responds with any relevant information. The rotation rate of the antenna 32, controlled via rotation mechanism 34, can be anywhere from once per second to once per day depending on the desired timeliness of the sensor information. Such a system reduces the required bandwidth needed to monitor a large number of infrastructure-mounted sensors.

The monitoring device 12 can also be configured to respond to a smartphone interface such as Wi-Fi, Bluetooth, or NFC (near field communication). The response is provided by a response device 30, whose construction and basic operational parameters are known to those skilled in the art to which this invention pertains. In this manner, an inspector or other interested person can locate and/or interrogate the monitoring device 12 using a smartphone. The monitoring device 12 can also be configured to permit a smartphone, or other portable device to communicate with a particular monitoring device 12 using the cell phone or Internet infrastructure.

In addition to providing changes in position, the GNSS sensor 14 can also be used to provide absolute location information of the monitoring device 12.

The monitoring device 12 can be powered with batteries which can be supplemented by energy harvesting from vibrations and/or solar or other radiation. In some cases, electrical power can be provided directly from an external source.

Although several preferred embodiments are illustrated and described above, there are possible combinations using other geometries, sensors, materials and different dimensions for the components that perform the same functions. Moreover, all of the inventions disclosed in the parent applications may be integrated into, incorporated with and combined with the inventions disclosed herein, and all such combinations are considered to be inventions.

Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention which is limited only by the following claims.

1. A system of monitoring a structure, comprising:
at least one monitoring arrangement attached at a respective location to the structure, each of said at least one monitoring arrangement comprising:
at least one inertial measurement unit (IMU) that measures acceleration and/or angular motion in any direction and rotation about any axis;
a Global Navigation Satellite System (GNSS) receiver that determines its location; and
a wireless communication system that transmits information derived from acceleration and/or angular motion measured by said at least one IMU and a location determination by said GNSS receiver.

2. The system of claim 1, wherein each of said at least one monitoring arrangement further comprises at least one sensor selected from a group consisting of a microphone, chemical sensor, a visual or IR light sensor, a radiation sensor, a magnetic sensor, and a strain sensor.

3. The system of claim 1, further comprising a wake-up sensor coupled to said at least one monitoring arrangement and that detects one of a predetermined number of conditions that relate to interaction of objects with the structure and for which monitoring of the structure is required, and when one of the predetermined number of conditions is detected, said wake-up sensor causing said at least one monitoring arrangement to go from an inactive phase in which data is not obtained to an active phase in which data is not obtained.

4. The system of claim 1, further comprising a wake-up sensor coupled to said at least one monitoring arrangement and that monitors at least one property of a monitoring location or the structure, and when the monitored at least one property exceeds a predetermined level, is below a predetermined threshold, or is within a range of interest detected, said wake-up sensor causing said at least one monitoring arrangement to go from an inactive phase in which data is not obtained to an active phase in which data is not obtained.

5. The system of claim 1, wherein said communication system comprises circuitry capable of providing high frequency radio frequency communications, a directional antenna configured to cover only a small angular slice in a vertical plane and a rotation mechanism that rotates said antenna, said communication system being configured to transmit the information after receiving a signal from said antenna.

6. An arrangement for determining relative motions between parts of a structure, comprising:
a plurality of monitoring arrangements each attached at a respective location to the structure, each of said monitoring arrangements comprising:
at least one inertial measurement unit (IMU) that measures acceleration and/or angular motion in any direction and rotation about any axis; and
a wireless communication system that transmits information derived from acceleration and/or angular motion measured by said at least one IMU;
a processor that analyzes the acceleration and/or angular motion measured by said at least one IMU of said monitoring arrangements and a distance between said monitoring arrangements to determine relative displacement between the locations at which said monitoring arrangements are attached to the structure.

7. The arrangement of claim 6, wherein said monitoring arrangements are attached to different parts of the structure.

8. The arrangement of claim 6, wherein each of said monitoring arrangements further comprises a Global Navigation Satellite System (GNSS) receiver that determines its location, said processor being further configured to analyze the location of said monitoring arrangements provided by said GNSS receivers to determine relative displacements between the locations at which said monitoring arrangements are attached to the structure.

9. The arrangement of claim 6, wherein each of said monitoring arrangements further comprises at least one sensor selected from a group consisting of a microphone, chemical sensor, a visual or IR light sensor, a radiation sensor, a magnetic sensor, and a strain sensor.

10. The arrangement of claim 6, further comprising a wake-up sensor coupled to said monitoring arrangements and that detects one of a predetermined number of conditions that relate to interaction of objects with the structure and for which monitoring of the structure is required, and when one of the predetermined number of conditions is detected, said wake-up sensor causing said monitoring arrangements to go from an inactive phase in which data is not obtained to an active phase in which data is not obtained.

11. The arrangement of claim 6, further comprising a wake-up sensor coupled to said monitoring arrangements and that monitors at least one property of a monitoring location or the structure, and when the monitored at least one property exceeds a predetermined level, is below a predetermined threshold, or is within a range of interest detected, said wake-up sensor causing said monitoring arrangements to go from an inactive phase in which data is not obtained to an active phase in which data is not obtained.

12. The arrangement of claim 6, wherein said communication system comprises circuitry capable of providing high frequency radio frequency communications, a directional antenna configured to cover only a small angular slice in a vertical plane and a rotation mechanism that rotates said antenna, said communication system being configured to transmit the information after receiving a signal from said antenna.

13. An arrangement for determining relative motions between parts of a structure, comprising:
a plurality of monitoring arrangements each attached at a respective location to the structure, each of said monitoring arrangements comprising:
a Global Navigation Satellite System (GNSS) receiver that determines its location; and
a wireless communication system that transmits information derived from a location determination by said GNSS receiver; and
a processor that analyzes the location of said monitoring arrangements provided by said GNSS receivers to determine relative displacements between the locations at which said monitoring arrangements are attached to the structure.

14. The arrangement of claim 13, wherein said monitoring arrangements are attached to different parts of the structure.

15. The arrangement of claim 13, wherein each of said monitoring arrangements further comprises at least one sensor selected from a group consisting of a microphone, chemical sensor, a visual or IR light sensor, a radiation sensor, a magnetic sensor, and a strain sensor.

16. The arrangement of claim 13, further comprising a wake-up sensor coupled to said monitoring arrangements and that detects one of a predetermined number of conditions that relate to interaction of objects with the structure and for which monitoring of the structure is required, and when one of the predetermined number of conditions is detected, said wake-up sensor causing said monitoring arrangements to go from an inactive phase in which data is not obtained to an active phase in which data is not obtained.

17. The arrangement of claim 13, further comprising a wake-up sensor coupled to said monitoring arrangements and that monitors at least one property of a monitoring location or the structure, and when the monitored at least one property exceeds a predetermined level, is below a predetermined threshold, or is within a range of interest detected, said wake-up sensor causing said monitoring arrangements to go from an inactive phase in which data is not obtained to an active phase in which data is not obtained.

18. The arrangement of claim 13, wherein said communication system comprises circuitry capable of providing high frequency radio frequency communications, a directional antenna configured to cover only a small angular slice in a vertical plane and a rotation mechanism that rotates said antenna, said communication system being configured to transmit the information after receiving a signal from said antenna.
